(19) United States
(12) Patent Application Publication
(10) Pub. No.: US 2025/0139850 A1
(43) Pub. Date: May 1, 2025

(54) Method of making images of rattlesnake scales into camouflage patterns

(71) Applicant: Austin Hull, Tucson, AZ (US)

(72) Inventor: Austin Hull, Tucson, AZ (US)

(21) Appl. No.: 18/495,704

(22) Filed: Oct. 26, 2023

(51) Int. Cl. G06T 11/00; F41H 3/00

(52) U.S. Cl. CPC G06T 11/001; F41H 3/00

(57) ABSTRACT

A method for making camouflage patterns from images of rattlesnake scales utilizing Adobe Photoshop software is described. This method decreases harsh lines that are created by the scales of the rattlesnake that may contribute to increased visibility by using various tools in Photoshop to blend and stretch the image. This method is to be used to make camouflage patterns for a range of terrains based on rattlesnake scales found in different regions of the world. The camouflage pattern can then be applied to a variety of objects such as apparel, accessories, and equipment for use by military personnel, hunters, or for personal use and/or fashion.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A LARGE TABLE, OR A COMPUTER PROGRAM LISTING APPENDIX ON READ-ONLY OPTICAL DISC

Not Applicable

### BACKGROUND OF THE INVENTION

Camouflage is a technique used by hunters and military personnel to conceal themselves in their surrounding environment to avoid detection. It is crucial to have a variety of camouflage patterns available to increase the versatility of camouflage when applied to apparel, accessories, and equipment in many different terrains including but not limited to mountain, forest, tundra, and desert. Many animals exhibit camouflage from which camouflage patterns can be adapted. Rattlesnakes are masters of disguise, utilizing their coloration and patterns to avoid being seen by both predators and prey. Rattlesnakes differ in color and pattern by region providing a plethora of options to create a variety of camouflage designs for use by military personnel, hunters, or fashion.

### BRIEF SUMMARY OF THE INVENTION

The disclosed method provides a basis for adapting camouflage patterns from the coloration and patterns of rattlesnakes. Rather than solely using a digital image of rattlesnake scales to create the camouflage pattern, this method describes how to alter an image(s) of rattlesnake scales utilizing Adobe Photoshop software to create a less static and more blended version of the pattern. This method decreases harsh lines created by the uniformity of the scales present on rattlesnakes to make a camouflage pattern that is more random in coloration and pattern to increase its likelihood to blend into a desired terrain.

### BRIEF DESCRIPTION OF THE SEVERAL VIEWS OF THE DRAWING

Patterns created with the described method are shown in the drawings along with applications for use of the pattern as shown with several drawings of the pattern being applied to apparel and accessories.

FIG. 1 view of 2D pattern made using the described method.

FIG. 2 front elevational view of the design in FIG. 1 applied to apparel;

FIG. 3 rear elevational view thereof.

FIG. 4 front elevational view of the design in FIG. 1 applied to an accessory;

FIG. 5 right side elevational view thereof; the left being a mirror image;

FIG. 6 rear elevational view thereof.

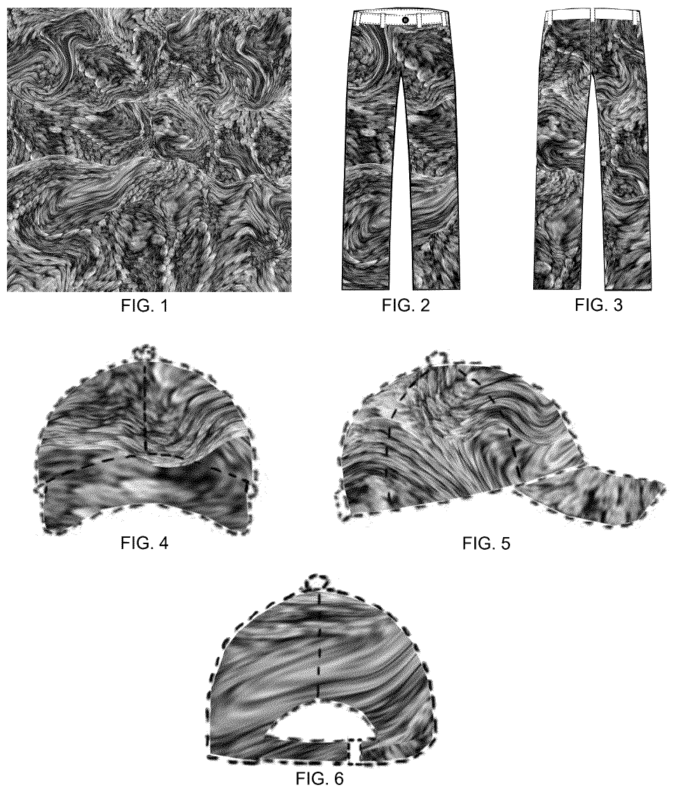

### DETAILED DESCRIPTION OF THE INVENTION

The described method details a way to make camouflage patterns from images of rattlesnake scales utilizing Adobe Photoshop 2024. In Adobe Photoshop 2024, create a custom 3000×3000 pixel at 300 ppi document. A 3000 by 3000-pixel white square should show on the screen. Next, choose an image with the desired rattlesnake scale patterns. This image should only show the pattern and not have any background (i.e. ground, sky trees). Insert the image onto the document and make multiple copies of the image as many times as needed to fill the 3000×3000-pixel grid. Arrange the images onto the document until all the white space is filled. Each copied image will create a new layer within Adobe Photoshop 2024. Next, select the first image layer and click ‘Filter’ on the top toolbar. Select the ‘Liquify’ option from the dropdown menu. By selecting this option, a modified window with the document and Liquify toolbar will appear on the screen. Under ‘Brush Tool Options’ in the Liquify toolbar select a brush size of around 600 pixels. When in liquifying mode, the brush tool can be used to drag around sections of the image until the pattern is stretched and blended to the desired look. To stretch the image, click on one section of the image and drag the mouse or trackpad in any direction. By clicking one section and moving in a circular direction, the image can be distorted in a wave-like pattern. Repeat stretching and blending with the liquifying tool for each image layer.

While making each desired pattern with the image of rattlesnake scales using the Adobe liquifying tool, images should not liquified passed the point of the scale patterns being unrecognizable. The number of scales should be minimized by blending with the liquifying tool to reduce any harsh lines; however, the pattern should still mimic the coloration and pattern of the rattlesnake.

After each image within the custom 3000×3000-pixel document is edited and liquified to the desired pattern, readjust the position of each separate image to cover the white space of the document. All images positioned next to each other without white space will create one full 3000×3000-pixel pattern. If needed, move or continue to liquify individual images to address any issues or areas of concern such as harsh lines. Save the image in desired format such as JPEG or PNG.

1. A method of making rattlesnake scale patterns into camouflage comprising the editing of rattlesnake scale patterns in Adobe Photoshop utilizing the liquifying tool provided within the program software.
